(19) United States
(12) Patent Application Publication
(10) Pub. No.: US 2007/0137370 A1
(43) Pub. Date: Jun. 21, 2007

(54) Arm mechanism for industrial robot

(75) Inventors: Atsushi Ichibangase, Fukuoka (JP); Kazuhiro Haniya, Fukuoka (JP); Takashi Sanada, Fukuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, KITAKYUSHU-SHI (JP)

(21) Appl. No.: 10/580,551

(22) PCT Filed: Aug. 27, 2004
(86) PCT No.: PCT/JP04/12788

§ 371 Date: May 26, 2006

(30) Foreign Application Priority Data
Nov. 28, 2003 (JP) 2003-399938
Jan. 26, 2004 (JP) 2004-16854

(51) Int. Cl. B25J 18/00

(52) U.S. Cl. 74/490.01

(57) ABSTRACT

It is an object of the invention to provide an arm mechanism for an industrial robot in which backlash can be reduced, a transmission loss of a driving force in a reduction gear can be reduced, and attachment dimensions of a feeding apparatus in the case where a conduit cable is disposed can be made small.

According to the invention, the mechanism has: a driving portion 10 which is separated from an R axis and disposed in a one-end side 3a of an arm portion 3, and in which a harmonic drive reduction gear 9 is coupled to an output shaft of an R-axis motor 8; a driven gear 11 which is supported to be rotatable around the R axis, and which is connected to another end side 3b of the arm portion 3; a passing hole 13 which is disposed along the R axis, and which is passed through the driven gear 11 in a manner that the hole is opened to the outside of the one-end side 3a of the arm portion 3, to communicate with the other-end side 3b of the arm portion 3; and a scissors gear 12 which is disposed on the output shaft of the harmonic drive reduction gear 9, and which meshes with the driven gear 11.

### TECHNICAL FIELD

The present invention relates to an arm mechanism which rotatably supports an arm portion of an industrial robot about a predetermined rotation axis, and particularly to an arm mechanism for an industrial robot which is configured so as to pass a cable or the like through an arm portion.

### BACKGROUND ART

FIG. 8 is a side view exemplifying a usual industrial robot.

The industrial robot as shown in FIG. 8 has a pedestal portion 1, a lower arm portion 2, an upper arm portion 3, and a wrist portion 4.

The pedestal portion 1 is disposed on a predetermined base 5. The pedestal portion 1 is structured with a stationary pedestal 1a which is fixed to the base 5, and a rotary pedestal 1b which is supported on the stationary pedestal 1a so as to be rotatable around an S axis (e.g. the base is horizontal, and the S axis is vertical). The lower arm portion 2 is formed into, for example, a vertically elongated shape, and the lower end of the portion is supported on the rotary pedestal 1b of the pedestal portion 1 to be rotatable around an L axis whose axis is perpendicular to the S axis. The upper arm portion 3 functioning as an arm portion is formed into, for example, a horizontally elongated shape, and a one-end side 3a of the portion is supported on the upper end of the lower arm portion 2 to be rotatable around a U axis whose axis is parallel to the L axis. Furthermore, the upper arm portion 3 is split into the one-end side 3a in the longitudinal direction, and an other-end side 3b in the longitudinal direction, and the other-end side 3b is supported on the one-end side 3a to be rotatable around an R axis (an axis elongating along in the longitudinal direction of the upper arm portion 3) functioning as a rotation axis. The wrist portion 4 is supported on the other end of the upper arm portion 3 to be rotatable around a B axis (an axis which is perpendicular to the R axis) Furthermore, the wrist portion 4 is supported on the other end of the upper arm portion 3 to be rotatable around a T axis (an axis which is perpendicular to the B axis). An end effector 6 is disposed in an end portion of the wrist portion 4 (for example, see JP-A-9-141589 or Japanese Patent No. 3,329,430).

There is another configuration in which, with respect to the pedestal portion 1, the lower arm portion 2, and the upper arm portion 3, a cavity is provided in each components so that an air hose is provided by passing it through those cavities (for example, see JP-A-7-246587).

As shown in FIG. 9, conventionally, a conduit cable 7 for feeding a welding wire or the like to the tip end of the end effector 6 is disposed. In this case, the conduit cable 7 is incorporated in the upper arm portion 3 so as not to interfere with a workpiece or a peripheral apparatus, being not shown, or the upper arm portion 3 while being in the operation.

Specifically to say, as shown in FIG. 9, the upper arm portion 3 is hollowed, and the conduit cable 7 is incorporated in the portion in a manner such that the cable elongates from the one-end side 3a to the other-end side 3b to reach the end effector 6. On the other hand, in the one-end side 3a of the upper arm portion 3, an R-axis motor 8 and a harmonic drive reduction gear 9 are fixed in a coupled form. An output shaft of the R-axis motor 8 is placed on the R axis, and coupled to an input shaft of the harmonic drive reduction gear 9. An output shaft of the harmonic drive reduction gear 9 is placed on the R axis, and fixed to the other-end side 3b of the upper arm portion 3. In this way, by the driving of the R-axis motor 8, the driving force is transmitted to the other-end side 3b of the upper arm portion 3 via the harmonic drive reduction gear 9, and the other-end side 3b turns around the R axis. In the case where the conduit cable 7 is incorporated in the upper arm portion 3, due to the R-axis motor 8 and the harmonic drive reduction gear 9 being disposed on the R axis of the one-end side 3a of the upper arm portion 3, the conduit cable 7 shall be inserted into a side portion of the one-end side 3a of the upper arm portion 3 to pass through the upper arm portion 3 in a manner to avoid the R-axis motor 8 and the harmonic drive reduction gear 9.

In the case where problems in the arm mechanism for an industrial robot are to be solved as described later, there arises a problem of backlash at first. For the purpose of eliminating such a backlash, a scissors gear is known (for example, see JP-A-2000-240763 or JP-A-2001-12582).

In the conventional arm mechanism for an industrial robot, in the case where the conduit cable 7 is inserted into a side portion of the one-end side 3a of the upper arm portion 3, however, a structure in which bending occurs in the conduit cable 7 is formed. As a result, there arise problems in that the feeding property of a welding wire or the like is lowered, and that the bending life of the conduit cable 7 itself is shortened. When the conduit cable 7 is thicker, moreover, the radius of curvature of a bent portion is reduced, and hence the problems arise more prominently.

For the problems, it is contemplated to form a configuration where, in order to lay the conduit cable 7 along the R axis without bending, the R-axis motor 8 is placed with being separated from the R axis, and the conduit cable 7 is passed through a shaft portion of the harmonic drive reduction gear 9 which is placed on the R axis. In this case, the R-axis motor 8 and the harmonic drive reduction gear 9 are coupled to each other by a transmission gear, etc.

In this configuration, however, there is a problem in that backlash occurs in the transmission gear which couples the R-axis motor 8 with the harmonic drive reduction gear 9, and, even when the machining accuracy of the transmission gear is enhanced, backlash remains large.

Since the conduit cable 7 is passed through the shaft portion of the harmonic drive reduction gear 9 which is placed on the R axis, there is a problem in that an outer frame of the harmonic drive reduction gear 9 is large, and the transmission loss of the driving force in the harmonic drive reduction gear 9 is increased. Therefore, a motor of a higher output power must be used as the R-axis motor 8.

The above-mentioned scissors gear is known as means for eliminating backlash. In the scissors gear, in order to dispose a spring between a main spur gear and a sub-spur gear, a groove in which the spring is to be placed is formed in the main spur gear and the sub-spur gear.

However, a high processing accuracy is requested in the groove in order that a spring pressure due to the spring is uniformly generated on the main spur gear and the sub-spur gear to avoid unbalanced load in the shaft portions of the gears.

In the scissors gear, furthermore, a high processing accuracy is requested in order that the overlapping faces of the main spur gear and the sub-spur gear overlap with each other without a gap, and slip in the turning direction is caused between the overlapping faces. Namely, a process of obtaining a high-precision scissors gear is not easily conducted, and involves a higher cost.

When the conduit cable 7 is disposed in the upper arm portion 3, a feeding apparatus 7A for feeding a welding wire is required as shown in FIGS. 9 and 10. In order to pass the conduit cable 7 through the upper arm portion 3, the feeding apparatus 7A is mounted to the one-end side 3a of the upper arm portion 3. As described above, however, the R-axis motor 8 and the harmonic drive reduction gear 9 are disposed on the R axis. In this regard, when the feeding apparatus 7A is attached to the one-end side 3a of the upper arm portion 3, the length F1 extending from just above the U axis in the R-axis direction comes to prolong as shown in FIG. 10. As the result, when the upper arm portion 3 is rotated around the U axis, the curvature radius r related to the length F1 is increased. Consequently, there is a problem in that a swing range where an interference with the outside is likely to occur might be produced in the one-end side 3a of the upper arm portion 3.

In view of the above-mentioned circumstances, it is an object of the invention to provide an arm mechanism for an industrial robot which is configured so that a cable is passed along a turn axis elongating along a longitudinal direction through an arm portion that supports another end side so as to be rotatable around the turn axis with respect. to one-end side in the longitudinal direction, and in which backlash can be reduced, a transmission loss of a driving force in a reduction gear can be reduced, and attachment dimensions of an external apparatus related to a cable can be made small.

It is another object of the invention to provide an arm mechanism for an industrial robot which allows a high-precision scissors gear for eliminating backlash to be economically obtained.

### DISCLOSURE OF THE INVENTION

In order to attain the objects, the invention 1 relates to an arm mechanism for an industrial robot, and is characterized in that the mechanism comprises: an arm portion of which one-end side in a longitudinal direction is supported at a predetermined portion, while other-end side in the longitudinal direction is rotatable around a rotation axis elongating in the longitudinal direction with respect to said one-end side; a driving portion, being apart from the rotation axis and disposed in said one-end side of said arm portion, in which a reduction gear is coupled to an output shaft of a driving motor; a driven gear which is supported to be rotatable around the rotation axis, and connected to said other-end side of said arm portion; a passing hole which is disposed along the rotation axis with passing through said driven gear in a manner such that said passing hole is opened to an outside of said one-end side of said arm portion so as to communicate with said other-end side of said arm portion, and a scissors gear which is disposed on an output shaft of said reduction gear so as to mesh with said driven gear.

The invention 2 relates to the arm mechanism for an industrial robot of the invention 1 above, and is characterized in that the scissors gear is configured by providing a form in which a main spur gear and a sub-spur gear that mesh with the driven gear, and that have a substantially same tooth shape overlap with each other, and urging the main spur gear and the sub-spur gear by a spring in opposing turning directions, the scissors gear comprises: accommodating grooves that are recessed in overlapping faces through which the main spur gear and the sub-spur gear overlap with each other, respectively, that are opposingly placed, and that internally accommodate the spring; spring receiving members which are fixed into the accommodating grooves, respectively, between which the spring is placed, and which hold a center of the spring in an elasticity direction with being coincident with positions of the overlapping faces; and a gap portion which is disposed between inner walls of the accommodating grooves and the spring receiving members in a manner that expansion and contraction of the spring due to relative movement between the main spur gear and the sub-spur gear is allowed in a manner that the main spur gear and the sub-spur gear mesh with the driven gear.

The invention 3 relates to the arm mechanism for an industrial robot of the invention 1 or 2 above, and is characterized in that the scissors gear is configured by providing a form in which a main spur gear and a sub-spur gear that mesh with the driven gear, and that have a substantially same tooth shape overlap with each other, and urging the main spur gear and the sub-spur gear by a spring in opposing turning directions, the scissors gear comprises: a slider which is disposed in a manner that the slider is fitted into one of the main spur gear and the sub-spur gear, and movement in the turning directions of another one of the main spur gear and the sub-spur gear is allowed; and an engaging member which engages with the main spur gear and the sub-spur gear via the slider in an overlapping manner.

As described above, according to the arm mechanism for an industrial robot of the invention, a cable or the like is placed substantially linearly inside the arm portion via the passing hole. Since the scissors gear which transmits the driving force of the driving portion to the driven gear is employed, particularly, backlash can be suppressed in driving transmission between the driving portion and the driven gear.

Since the reduction gear is separated from the rotation axis, the mechanism does not have the configuration in which the cable or the like is passed through the reduction gear. Therefore, the outer frame of the reduction gear can be made small, the transmission loss of the driving force in the reduction gear can be reduced, and a motor of a lower output power can be used as the driving motor. Since the driving motor and the reduction gear are separated from the rotation axis, attachment dimensions of an external apparatus related to the cable can be correspondingly made small.

Furthermore, the scissors gear conducts holding while the center in the elasticity direction of the spring is made coincident with the positions of the overlapping faces through which the main spur gear and the sub-spur gear overlap with each other, by the holding portions of the spring receiving members.

In the scissors gear, moreover, the gap portions allow the spring to expand and contract. Therefore, the urging force of the spring is produced uniformly and without load between the main spur gear and the sub-spur gear, and hence it is possible to obtain a high-precision scissors gear in which unbalanced load in the shaft portions of the gears is avoided.

Because of the simple configuration which has the accommodating grooves and the spring receiving members, the process is easily conducted, and the high-precision scissors gear can be economically obtained.

In the scissors gear, the main spur gear and the sub-spur gear are engaged with each other in an overlapping manner via a slider which is fitted into one of the main spur gear and the sub-spur gear, and which allows movement in the turning directions of another one of the main spur gear and the sub-spur gear.

Therefore, the main spur gear and the sub-spur gear can overlap with each other without a gap, and movement of the main spur gear and the sub-spur gear in the opposing turning directions can be smoothly conducted.

### BRIEF DESCRIPTION OF THE DRAWINGS

FIG. 1 is a partially cutaway plan view showing an embodiment of the arm mechanism for an industrial robot of the invention.

FIG. 2 is a side view showing the embodiment of the arm mechanism for an industrial robot of the invention.

FIG. 3 is a plan view showing a scissors gear.

FIG. 4 is an enlarged section view taken along I-I of FIG. 3.

FIG. 5 is a plan view of a main spur gear of the scissors gear as viewed from a side of an overlapping face.

FIG. 6 is a plan view of a sub-spur gear of the scissors gear as viewed from a side of an overlapping face.

FIG. 7 is an enlarged section view taken along II-II of FIG. 3.

FIG. 8 is a side view exemplarily showing a usual industrial robot.

FIG. 9 is a partially cutaway plan view showing a conventional arm mechanism for an industrial robot.

FIG. 10 is a side view showing the conventional arm mechanism for an industrial robot.

In the figures, the reference numeral 3 denotes an upper arm portion, 3a denotes a one-end side, 3b denotes another end side, 7 denotes a conduit cable, 7A denotes a feeding apparatus, 8 denotes an R-axis motor, 9 denotes a harmonic drive reduction gear, 10. denotes a driving portion, 11 denotes a driven gear, 12 denotes a scissors gear (drive transmitting portion), 12a denotes a main-spur gear, 12b denotes a sub-spur gear, 12c denotes a spring, 13 denotes a passing hole, 121a and 121b denote an overlapping face, 122a and 122b denote an accommodating groove, 123a and 123b denote a circular hole portion, 124 denotes a bolt hole, 125 denotes a fitting recess, 126 denotes a loosely inserting hole, 127 denotes a step portion, 128 denotes a stepped recess, 129.denotes a shaft portion, 129a denotes a bolt hole, 130a and 130b denote a spring receiving member, 131a and 131b denote a leg portion, 132a and 132b denote a receiving portion, 133a and 133b denote a holding portion, 140a and 140b denote a gap portion, 150 denotes a bolt, 160 denotes a slider, 160a denotes a fitting portion, 160b denotes a flange portion, 160c denotes a through hole, and 170 denotes a provisional fixing bolt.

### BEST MODE FOR CARRYING OUT THE INVENTION

Hereinafter, a preferred embodiment of the arm mechanism for an industrial robot of the invention will be described in detail with reference to the drawings. The invention is not restricted to the embodiment.

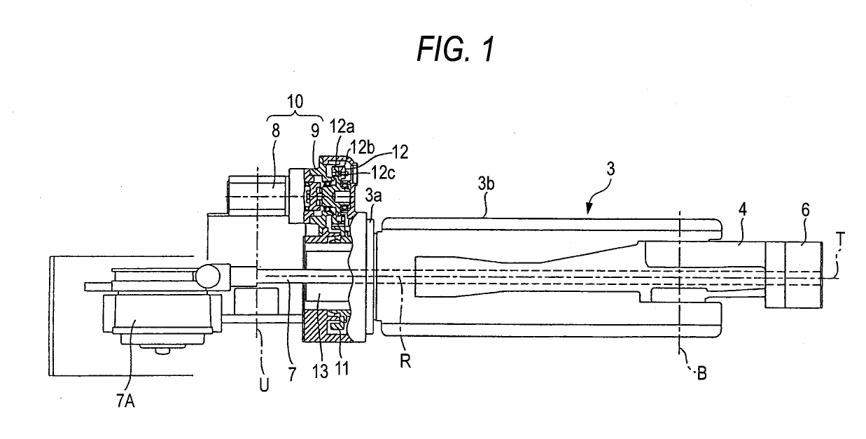

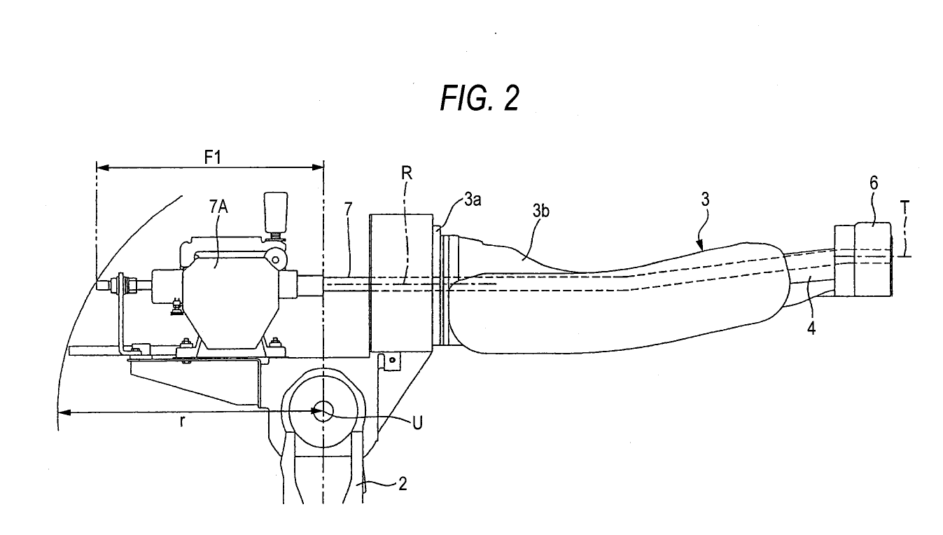

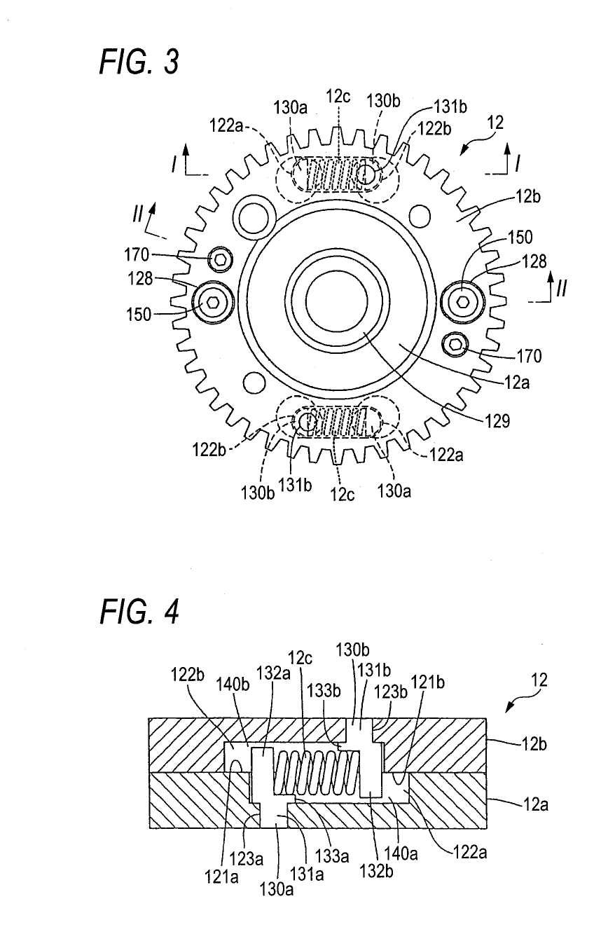

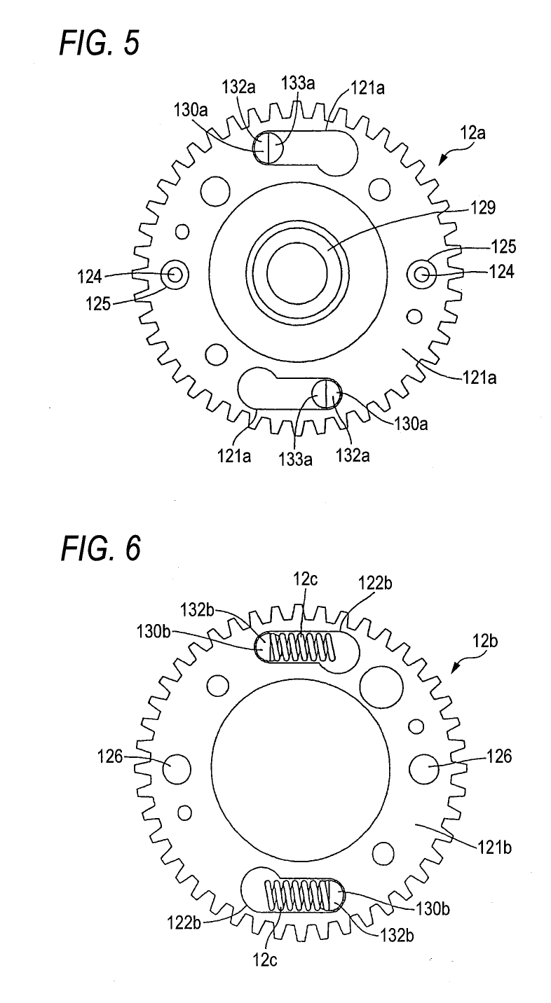

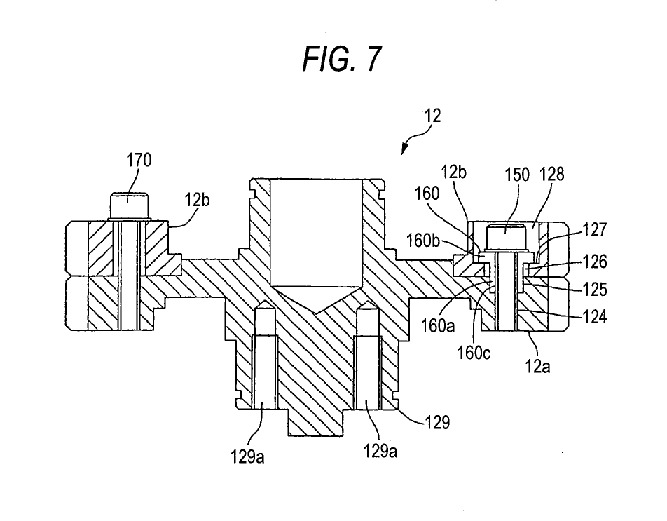

FIG. 1 is a partially cutaway plan view showing the embodiment of the arm mechanism for an industrial robot of the invention, FIG. 2 is a side view showing the embodiment of the arm mechanism for an industrial robot of the invention, FIG. 3 is a plan view showing a scissors gear, FIG. 4 is an enlarged section view taken along I-I of FIG. 3, FIG. 5 is a plan view of a main spur gear of the scissors gear as viewed from a side of an overlapping face, FIG. 6 is a plan view of a sub-spur gear of the scissors gear as viewed from a side of an overlapping face, and FIG. 7 is an enlarged section view taken along II-II of FIG. 3. In the embodiment described below, similar portions as those of the above-described background art will be described with annexing the same reference numerals.

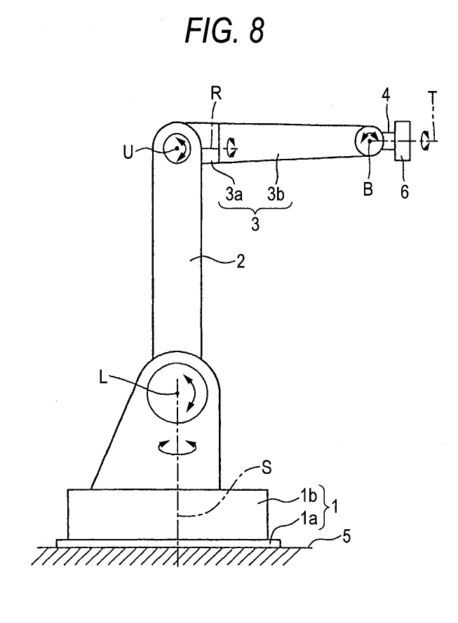

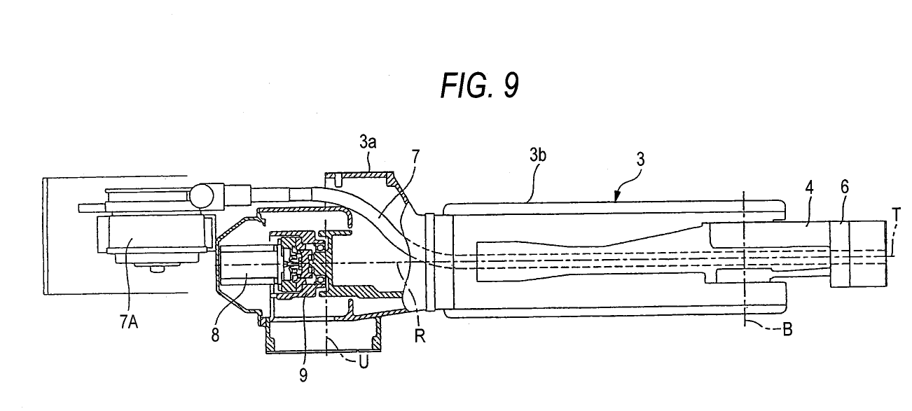

As shown in FIGS. 1 and 2, the arm mechanism for an industrial robot of the embodiment relates the upper arm portion 3 shown in FIG. 8 and functioning as an arm portion. The upper arm portion 3 is formed into, for example, a horizontally elongated shape, and the one-end side 3a of the portion is supported on the upper end of the lower arm portion 2 functioning as a predetermined portion, to be rotatable around the U axis (the axis which is parallel to the L axis in FIG. 8). The upper arm portion 3 is split into the one-end side 3a in the longitudinal direction, and the other-end side 3b in the longitudinal direction, and the other-end side 3b is supported on the one-end side 3a to be rotatable around the R axis (the axis elongating along in the longitudinal direction of the upper arm portion 3) functioning as a rotation axis. On the other-end side 3b of the upper arm portion 3, there is the wrist portion 4 which is disposed to be rotatable around the B axis (the axis which is perpendicular to the R axis). The wrist portion 4 is supported on the other end of the upper arm portion 3 to be rotatable around the T axis (the axis which is perpendicular to the B axis). The end effector 6 is disposed in an end portion of the wrist portion 4.

The upper arm portion 3 is hollowed. A driving mechanism which drives rotation of the other-end side 3b about the R axis is incorporated in the one-end side 3a of the upper arm portion 3. The driving mechanism consists of a driving portion 10, a driven gear 11, and a drive transmitting portion 12.

The driving portion 10 is disposed in the one-end side 3a of the upper arm portion 3 with being separated from the R axis, and consists of the R-axis motor 8 functioning as a driving motor, and the harmonic drive reduction gear 9. The output shaft of the R-axis motor 8 is directly coupled to the input shaft of the harmonic drive reduction gear 9. In the driving portion 10, namely, the turning of the R-axis motor 8 is reduced without loss by the harmonic drive reduction gear 9. The harmonic drive reduction gear 9 produces a very small degree of backlash.

The driven gear 11 is supported to be rotatable around the R axis, and connected to the other-end side 3b of the upper arm portion 3. The driven gear 11 consists of a spur gear which is supported to be rotatable around the R axis.

A passing hole 13 is disposed in the driven gear 11. The passing hole 13 is disposed along the R axis, and passed through the driven gear 11 in a manner that the hole is opened to the outside of the one-end side 3a of the upper arm portion 3, to communicate with the other-end side 3b of the upper arm portion 3.

The drive transmitting portion 12 is coupled to the output shaft of the harmonic drive reduction gear 9. The drive transmitting portion 12 is configured as a scissors gear, and consists of a main spur gear 12a which is rotated in accordance with the rotation of the output shaft of the harmonic drive reduction gear 9, and a sub-spur gear 12b which has a diameter that is approximately equal to that of the main spur gear 12a, and which overlaps with the main spur gear 12a via a spring 12c. The scissors gear 12 serving as the drive transmitting portion meshes with the driven gear 11 in a manner that the teeth of the driven gear 11 are sandwiched by the elastic force of the spring 12c between those of the main spur gear 12a and the sub-spur gear 12b. Namely, the scissors gear 12 couples the harmonic drive reduction gear 9 of the driving portion 10 with the driven gear 11 to transmit the driving force of the driving portion 10 to the driven gear 11. In the scissors gear 12, occurrence of backlash with respect to the driven gear 11 is suppressed by the sandwiching of the teeth of the driven gear 11 between those of the main spur gear 12a and the sub-spur gear 12b.

The scissors gear 12 is configured by providing the form in which the main spur gear. 12a and the sub-spur gear 12b that mesh with the driven gear 11, and that have the substantially same tooth shape overlap with each other, and urging the main spur gear 12a and the sub-spur gear 12b by the spring 12c in opposing turning directions. As shown in FIGS. 3 to 6, in the scissors gear 12, the spring 12c is accommodated in accommodating grooves 122a, 122b that are recessed in overlapping faces 121a, 121b through which the main spur gear 12a and the sub-spur gear 12b overlap with each other. The accommodating grooves 122a, 122b are longitudinally formed along tangential lines in the opposing turning directions of the main spur gear 12a and the sub-spur gear 12b, and opposingly placed in a manner that their openings are opposed to each other, thereby forming a space accommodating the spring 12c.

Spring receiving members 130a, 130b are fixed to the accommodating grooves 122a, 122b, respectively. The spring receiving member 130a is fixed to the accommodating groove 122a by pressingly inserting a substantially columnar leg portion 131a into a circular hole portion 123a which is formed in the bottom of the accommodating groove 122a. Furthermore, the spring receiving member 130a has a semicolumnar receiving portion 132a which extends in the accommodating groove 122b opposed to the accommodating groove 122a. The spring receiving member 130b is fixed to the accommodating groove 122b by pressingly inserting a substantially columnar leg portion 131b into a circular hole portion 123b which is formed in the bottom of the accommodating groove 122b. Furthermore, the spring receiving member 130b has a semicolumnar receiving portion 132b which extends in the accommodating groove 122a opposed to the accommodating groove 122b.

The spring 12c is placed between the receiving portions 132a, 132b. Holding portions 133a, 133b which butt against side portions of the spring 12c are disposed in basal end portions of the receiving portions 132a, 132b, respectively. The holding portions 133a, 133b hold the spring 12c in a manner that the spring 12c is sandwiched. Therefore, the spring 12c is held while its center in the elasticity direction is coincident with the positions of the overlapping faces 121a, 121b through which the main spur gear 12a and the sub-spur gear 12b overlap with each other.

A gap portion 140b is disposed between the receiving portion 132a of the spring receiving member 130a, and the inner wall which is extended from the receiving portion 132a, and which is on the side of the accommodating groove 122b. The gap portion 140b is formed by expanding a part of the accommodating groove 122b, between the inner wall of the accommodating groove 122b and the receiving portion 132a. A gap portion 140a is disposed between the receiving portion 132b of the spring receiving member 130b, and the inner wall which is extended from the receiving portion 132b, and which is on the side of the accommodating groove 122a. The gap portion 140a is formed by expanding a part of the accommodating groove 122a, between the inner wall of the accommodating groove 122a and the receiving portion 132b. In a state where the main spur gear 12a and the sub-spur gear 12b mesh with the driven gear 11 and the spring receiving members 130a, 130b (the receiving portions 132a, 132b) receive the urging force of the spring 12c, as shown in FIG. 4, the gap portions 140a, 140b allow the spring 12c to expand and contract while avoiding contact between the inner wall of the accommodating groove 122aand the receiving portion 132b, and also that of the inner wall of the accommodating groove 122b and the receiving portion 132a.

The configuration in which the accommodating grooves 122a, 122b and the spring receiving members 130a, 130b accommodate and hold the spring 12c as described above is disposed in plural portions (in the embodiment, two places) at positions which are symmetrical with respect the center in the turning direction of the main spur gear 12a and the sub-spur gear 12b.

In the scissors gear 12, as shown in FIG. 7, the main spur gear 12a and the sub-spur gear 12b are engaged in the overlapping state by a bolt 150 functioning as an engaging member. In the main spur gear 12a, a bolt hole 124 with which the bolt 150 is screwed, and a fitting recess 125 which is larger in diameter than the bolt hole 124, and which is opened on the side of the overlapping face 121a while communicating with the bolt hole 124 are disposed. In the sub-spur gear 12b, a stepped recess 128 is disposed which has a loosely inserting hole 126 that is larger in diameter than the fitting recess 125, and that is passed through toward the overlapping face 121b in a manner that the hole is opposed to the fitting recess 125, and which is opened to the outside of. the sub-spur gear 12b via a step portion 127.

A slider 160 is placed in the fitting recess 125, the loosely inserting hole 126, and the stepped recess 128. The slider 160 is formed to have a fitting portion 160a which is fitted into the fitting recess 125 while being loosely inserted into the loosely inserting hole 126, and a flange portion 160b which is engaged with the step portion 127 while being loosely inserted into the stepped recess 128. A through hole 160c through which the bolt 150 is passed is disposed in the center of the slider 160. Namely, the slider 160 is fitted into the main spur gear 12a by fitting the fitting portion 160a into the fitting recess 125. Furthermore, the slider 160 is engaged with the step portion 127 while the fitting portion 160a is loosely inserted into the loosely inserting hole 126, and the flange portion 160b is loosely inserted into the stepped recess 128, thereby allowing the sub-spur gear 12b to be moved in the turning direction. The bolt 150 is passed through the through hole 160c of the slider 160, and screwed with the bolt hole 124, whereby the main spur gear 12a and the sub-spur gear 12b are engaged with each other in a manner that the gears overlap with each other via the slider 160. In the slider 160, the fitting portion 160a is fitted into the fitting recess 125 in the manner that the main spur gear 12a and the sub-spur gear 12b overlap with each other, thereby forming a small gap between the flange portion 160b and the step portion 127. This small gap enables the main spur gear 12a and the sub-spur gear 12b to be smoothly moved in the opposing turning directions. In the scissors gear 12, the shapes of the teeth of the spur gears 12a, 12b are delicately different from one another, so that variation of the backlash amount depending on the place of the meshing with the driven gear 11 is absorbed. Therefore, the main spur gear 12a and the sub-spur gear 12b frequently slide with each other. The small gap enables frequent sliding movement between the spur gears 12a, 12b to be smoothly conducted.

The configuration in which the bolt 150 is screwed as described above is disposed in plural portions (in the embodiment, two places) at positions which are symmetrical with respect the center in the turning direction of the main spur gear 12a and the sub-spur gear 12b, and between the above-described configurations for accommodating and holding the springs 12c.

In the scissors gear 12 in the embodiment, the side on the main spur gear 12a is coupled to the output shaft of the harmonic drive reduction gear 9. Specifically, as shown FIG. 7, a shaft portion 129 is formed integrally with the main spur gear 12a. A bolt hole 129a for coupling to the output shaft is disposed in the shaft. portion 129. The main spur gear 12a is formed so that the thickness of the peripheral portion of the shaft portion 129 excluding a tooth tip portion which overlaps with the sub-spur gear 12b is smaller than the total thickness of the main spur gear 12a and the sub-spur gear 12b which overlap with each other, so that the whole scissors gear 12 is lightened. As shown in FIGS. 3 and 7, provisional fixing bolts 170 are disposed in the scissors gear 12. The provisional fixing bolts 170 are used in order to, when the scissors gear 12 is to be installed to the driven gear 11, align the tooth surfaces of the main spur gear 12a and the sub-spur gear 12b with each other. Namely, after the scissors gear 12 in which the tooth surfaces of the main spur gear 12a and the sub-spur gear 12b substantially completely overlap with each other by the provisional fixing bolts 170 meshes with the driven gear 11, the provisional fixing bolts 170 are detached from the scissors gear, thereby producing a form in which the teeth of the driven gear 11 are sandwiched by the spur gears 12a, 12b and occurrence of backlash is suppressed.

In the thus configured scissors gear 12, holding is conducted while the center in the elasticity direction of the springs 12c is made coincident with the positions of the overlapping faces 121a, 121b through which the main spur gear 12a and the sub-spur gear 12b overlap with each other, by the holding portions 133a, 133b of the spring receiving members 130a, 130b. In the scissors gear 12, moreover, the gap portions 140a, 140b allow the springs 12c to expand and contract. According to the configuration, the urging forces of the springs 12c are produced uniformly and without load between the main spur gear 12a and the sub-spur gear 12b, and hence it is possible to obtain a high-precision scissors gear 12 in which unbalanced load in the shaft portions of the gears is avoided. Because of the simple configuration in which the spring receiving members 130a, 130b are pressingly inserted into the accommodating grooves 122a, 122b, the process is easily conducted, and the high-precision scissors gear 12 can be economically obtained.

In the thus configured scissors gear 12, the main spur gear 12a and the sub-spur gear 12b are engaged with each other in the manner that the gears overlap with each other via the sliders 160 which are fitted into the main spur gear 12a, and which allow movement of the sub-spur gear 12b in the turning direction. Therefore, the main spur gear 12a and the sub-spur gear 12b can overlap without a gap, and movement of the sub-spur gear 12b in the turning direction can be smoothly conducted.

In the thus configured driving mechanism, when the R-axis motor 8 of the driving portion 10 is driven, the turning is transmitted to the driven gear 11 via the scissors gear 12 while the speed is reduced by the harmonic drive reduction gear 9, to rotate the other-end side 3b of the upper arm portion 3 about the R axis. Then, backlash which may occur in this case is suppressed by the harmonic drive reduction gear 9 and the scissors gear 12.

In the configuration having the driving mechanism, the conduit cable 7 for feeding a welding wire or the like to the tip end of the end effector 6 is disposed. In this case, the conduit cable 7 is passed along the R axis through the passing hole 13 which is opened to the outside of the one-end side 3a of the upper arm portion 3. According to the configuration, the conduit cable 7 is placed substantially linearly along the R axis inside the one-end side 3a of the upper arm portion 3, and reaches the tip end of the end effector 6 via the other-end side 3b of the upper arm portion 3.

When the conduit cable 7 is disposed in the upper arm portion 3, the feeding apparatus 7A is required as an external apparatus for feeding the welding wire. In order to pass the conduit cable 7 through the upper arm portion 3, the feeding apparatus 7A is attached to the upper end of the lower arm portion 2 with facing the opening of the one-end side 3a of the upper arm portion 3 which is disposed by the passing hole 13.

In the above-described arm mechanism for an industrial robot, therefore, the driving portion 10 is disposed on the one-end side 3a of the upper arm portion 3 with being separated from the R axis, the driven gear 11 is supported to as to be rotatable around the R axis, and the passing hole 13 which is passed to the other-end side 3b of the upper arm portion 3 is disposed along the R axis in the driven gear 11 in a manner that the hole is opened to the outside of the one-end side 3a of the upper arm portion 3. According to the configuration, the conduit cable 7 can be placed substantially linearly inside the upper arm portion 3 via the passing hole 13. As a result, the feeding property of the welding wire or the like is improved, and the bending life of the conduit cable 7 itself is prolonged. The substantially linear arrangement enables the conduit cable 7 which is relatively thick to be used.

Since the scissors gear 12 is employed as the drive transmitting portion for transmitting the driving force of the driving portion 10 to the driven gear 11, backlash can be suppressed in driving transmission between the driving portion 10 and the driven gear 11.

Unlike the conventional art, the mechanism does not have the configuration in which the conduit cable 7 is passed through the shaft portion of the harmonic drive reduction gear 9 which is placed on the R axis. Therefore, the outer frame of the harmonic drive reduction gear 9 can be made small, and the transmission loss of the driving force in the harmonic drive reduction gear 9 can be reduced. Consequently, a motor of a lower output power can be used as the R-axis motor 8. In the harmonic drive reduction gear 9, backlash is very small, and hence backlash can be suppressed.

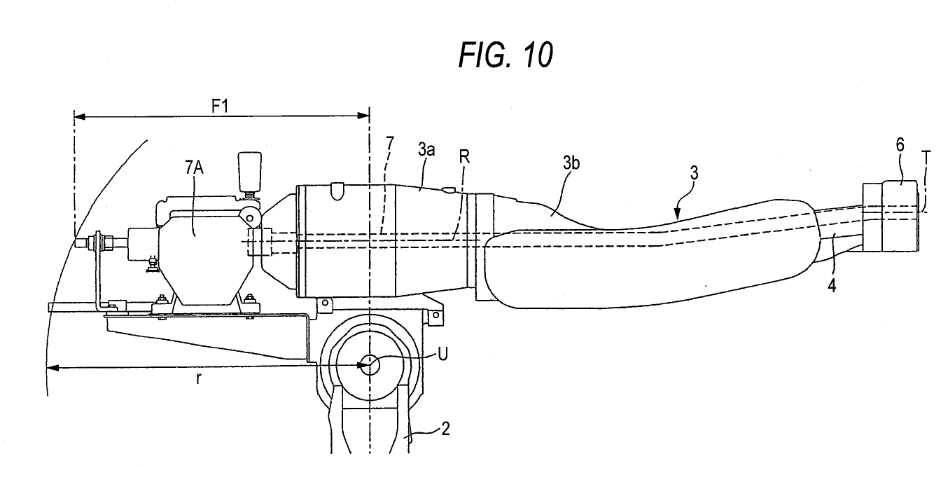

Furthermore, the R-axis motor 8 and the harmonic drive reduction gear 9 which serve as the driving portion 10 are separated from the R axis. When the feeding apparatus 7A is attached as shown in FIG. 2, therefore, the dimension F1 extending from just above the U axis in the R-axis direction is shorter as compared with the conventional art (FIG. 10). Namely, the attachment dimensions of the feeding apparatus 7A can be made small. As a result, the curvature radius r in the case where the upper arm portion 3 is rotated about the U axis is reduced as shown in FIG. 2, and hence the swing range in the one-end side 3a of the upper arm portion 3 can be made small.

### INDUSTRIAL APPLICABILITY

As described above, the arm mechanism for an industrial robot of the invention is configured so that the conduit cable is passed along the turn axis elongating along the longitudinal direction through the arm portion that rotatably supports about the turn axis the other-end side with respect to the one-end side in the longitudinal direction, and therefore the mechanist is suitable for reducing backlash, reducing a transmission loss of the driving force in the reduction gear, and decreasing the attachment dimensions of the feeding apparatus in the case where the conduit cable is disposed.

1. An arm mechanism used for an industrial robot comprising:
an arm portion of which one-end side in a longitudinal direction is supported at a predetermined portion, while other-end side in the longitudinal direction is rotatable around a rotation axis elongating in the longitudinal direction with respect to said one-end side;
a driving portion, being apart from the rotation axis and disposed in said one-end side of said arm portion, in which a reduction gear is coupled to an output shaft of a driving motor;
a driven gear which is supported to be rotatable around the rotation axis, and connected to said other-end side of said arm portion;
a passing hole which is disposed along the rotation axis with passing through said driven gear in a manner such that said passing hole is opened to an outside of said one-end side of said arm portion so as to communicate with said other-end side of said arm portion; and
a scissors gear which is disposed on an output shaft of said reduction gear so as to mesh with said driven gear.

2. An arm mechanism for an industrial robot according to claim 1, wherein said scissors gear is configured by providing a form in which a main spur gear and a sub-spur gear that mesh with said driven gear, and that have a substantially same tooth shape overlap with each other, and urging said main spur gear and said sub-spur gear by a spring in opposing turning directions,
said scissors gear comprises:
accommodating grooves that are recessed in overlapping faces through which said main spur gear and said sub-spur gear overlap with each other, respectively, that are opposingly placed, and that internally accommodate said spring;
spring receiving members which are fixed into said accommodating grooves, respectively, between which said spring is placed, and which hold a center of said spring in an elasticity direction with being coincident with positions of said overlapping faces; and
a gap portion which is disposed between inner walls of said accommodating grooves and said spring receiving members in a manner that expansion and contraction of said spring due to relative movement between said main spur gear and said sub-spur gear is allowed in a manner that said main spur gear and said sub-spur gear mesh with said driven gear.

3. An arm mechanism for an industrial robot according to claim 1 or 2, wherein said scissors gear is configured by providing a form in which a main spur gear and a sub-spur gear that mesh with said driven gear, and that have a substantially same tooth shape overlap with each other, and urging said main spur-gear and said sub-spur gear by a spring in opposing turning directions,
said scissors gear comprises:
a slider which is disposed in a manner that said slider is fitted into one of said main spur gear and said sub-spur gear, and movement in the turning directions of another one of said main spur gear and said sub-spur gear is allowed; and
an engaging member which engages with said main spur gear and said sub-spur gear via said slider in an overlapping manner.
